(19) United States
(12) Patent Application Publication
(10) Pub. No.: US 2009/0154937 A1
(43) Pub. Date: Jun. 18, 2009

(54) APPARATUS FOR RESTORING CLOCK SIGNAL BY USING CIRCULATOR

(75) Inventors: Sang Kyu LIM, Daejeon (KR); Je Soo KO, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/201,532

(22) Filed: Aug. 29, 2008

(30) Foreign Application Priority Data
Dec. 18, 2007 (KR) 10-2007-0133746
May 1, 2008 (KR) 10-2008-0041069

(51) Int. Cl. H04B 10/00

(52) U.S. Cl. 398/155

(57) ABSTRACT

Provided is an apparatus and method for restoring clock signals by using a circulator in an optical transmission system. The apparatus includes a circulator, which allows one of N types of input data signals having different transmission speeds to circulate in a single direction, band pass filters, which extract N types of clock frequency components respectively corresponding to each transmission speed of the N types of input data signals, and clock amplifiers, which amplify each of the N types of clock frequency components.

### CROSS-REFERENCE TO RELATED PATENT APPLICATION

This application claims the benefit of Korean Patent Application Nos. 10-2007-0133746, filed on Dec. 18, 2007 and 10-2008-0041069, filed on May 1, 2008, in the Korean Intellectual Property Office, the disclosure of which is incorporated herein in its entirety by reference.

### BACKGROUND OF THE INVENTION

1. Field of the Invention

The present invention relates to a method and apparatus for restoring clock signals, which electrically restore the clock signals from data signals received at a receiver of an optical transmission system.

The present invention is derived from a research project supported by the Information Technology (IT) Research & Development (R&D) program of the Ministry of Information and Communication (MIC) and the Institute for Information Technology Advancement (IITA) of South Korea [2006-S-060-02, Development of OTH Based 40G-Class Multiservice Transmission Technology].

2. Description of the Related Art

A receiver of a conventional optical transmission system requires an apparatus for extracting or restoring a clock signal, which restores a clock signal from a received data signal and supplies the restored clock signal to a data restoration block and a demultiplexing block. In other words, the receiver of the conventional optical transmission system restores and demultiplexes data by using the restored clock signal.

However, a conventional open-loop type apparatus for restoring a clock signal using a passive filter has been operated only at one transmission speed. For example, signals having a 40 Gbit/s-class transmission speed include an STM-256 signal (39.81312 Gbit/s), wherein four STM-64 signals (9.95328 Gbit/s) based on synchronous digital hierarchy (SDH) are multiplexed, a 42.8369 Gbit/s signal, wherein four OTU-2 signals (10.709225 Gb/s) based on optical transport hierarchy (OTH) are multiplexed, and an OTU-3 signal (43.018413 Gbit/s). However, the conventional open-loop type apparatus for restoring a clock signal can only extract a clock signal corresponding to one of the above three transmission speeds.

Accordingly, whenever transmission speed changes, a band pass filter block inside the apparatus for restoring a clock signal or the apparatus itself needs to be changed according to the transmission speed.

### SUMMARY OF THE INVENTION

The present invention provides a method and device for restoring each clock signal corresponding to various transmission speeds in one apparatus for restoring the clock signals, even when at least one data signal having different transmission speeds are inputted selectively to the apparatus for restoring the clock signals.

The present invention also provides an apparatus for restoring clock signals, which can process the clock signals having different transmission speeds without changing hardware, in an optical transmission system supporting different types of data transmission having different transmission speeds.

According to an aspect of the present invention, there is provided an apparatus for restoring clock signals by using a circulator in an optical transmission system, the apparatus including: a circulator, which has N output ports and, upon receiving selectively one of N types of input data signals having N types of transmission speeds, allows the one input data signal to circulate in a single direction; and N types of band pass filters, which respectively extract N types of clock frequency components respectively corresponding to the N types of transmission speeds, wherein each band pass filter passes the received input data signal when a clock frequency component corresponding to the transmission speed of the received input data signal corresponds to a pass-band, and reflects the received input data signal to the circulator when the clock frequency component corresponding to the transmission speed of the received input data signal does not correspond to the pass-band.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an apparatus for restoring a clock signal, which extracts a clock signal from a return to zero (RZ) data signal, having a fixed transmission speed, and including a clock frequency component;

FIG. 2 is a block diagram illustrating an apparatus for restoring a clock signal, which extracts a clock signal from a non-return to zero (NRZ) data signal, having a fixed transmission speed, and not including a clock frequency component;

FIG. 3 is a diagram illustrating an apparatus for restoring clock signals, which restores the clock signals corresponding to each transmission speed from RZ data signals having different transmission speeds, according to an embodiment of the present invention;

FIGS. 4A and 4B are diagrams illustrating an apparatus for restoring clock signals, which restores the clock signals corresponding to each transmission speed from NRZ data signals having different transmission speeds, according to an embodiment of the present invention;

FIG. 5 is a diagram illustrating an internal structure of a clock generator in FIGS. 4A and 4B, according to an embodiment of the present invention;

FIG. 6 is a conceptual diagram illustrating an apparatus for restoring clock signals, according to an embodiment of the present invention; and

FIG. 7 is a conceptual diagram illustrating an apparatus for restoring clock signals from NRZ data, according to an embodiment of the present invention.

### DETAILED DESCRIPTION OF THE INVENTION

The present invention will now be described more fully with reference to the accompanying drawings, in which exemplary embodiments of the invention are shown. In the drawings, like reference numerals denote like elements.

Also, while describing the present invention, detailed descriptions about related well-known functions or configurations that may diminish the clarity of the points of the present invention are omitted.

The invention may be embodied in many different forms and should not be construed as being limited to the embodiments set forth herein; rather, these embodiments are provided so that this disclosure will be thorough and complete, and will fully convey the concept of the invention to those of ordinary skill in the art.

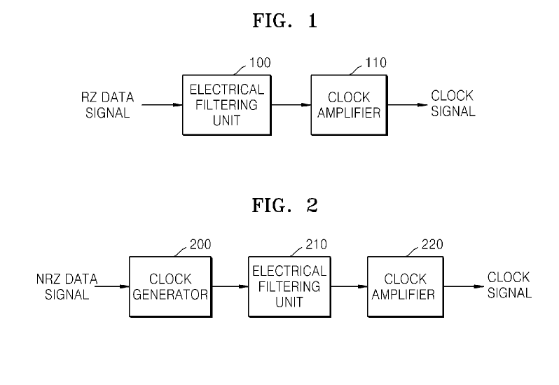

FIGS. 1 and 2 illustrate apparatuses for restoring a clock signal, which use a conventional electrical passive filter. Such apparatuses are also called passive type or open-loop type apparatuses.

FIG. 1 is a block diagram illustrating an apparatus for restoring a clock signal, which restores a clock signal from a return to zero (RZ) data signal including a clock frequency component corresponding to a transmission speed of the RZ data signal, and FIG. 2 is a block diagram illustrating an apparatus for restoring a clock signal, which restores a clock signal from an NRZ data signal not including a clock frequency component corresponding to a transmission speed of the NRZ data signal.

The apparatus of FIG. 1 includes an electrical filtering unit 100 and a clock amplifier 110. The apparatus of FIG. 2 includes a clock generator 200, an electrical filtering unit 210, and a clock amplifier 220.

Functions of each element are as follows. First, the clock generator 200 generates a clock frequency component corresponding to a transmission speed of a data signal from a received NRZ data signal. Then, the electrical filtering units 100 and 210 filter only a predetermined clock frequency component from the data signal including clock frequency components. Next, the clock amplifiers 110 and 220 amplify clock signals respectively extracted from the electrical filtering units 100 and 210.

When a transmission speed of data is lower than several Gbit/s, the electrical filtering units 100 and 210 are generally realized by using a tank circuit that uses a passive device such as a resistor (R), an inductor (L), and a capacitor (C), or a surface acoustic wave (SAW) filter. However, when a transmission speed is above several Gbit/s, it is difficult to manufacture a tank circuit or a SAW filter. Accordingly, the electrical filtering units 100 and 210 are realized by using dielectric resonators having a high Q value and excellent microwave characteristics.

Also, in order to obtain a high quality clock signal, the electrical filtering units 100 and 210 are manufactured to have a high Q value (center frequency/3-dB bandwidth). Here, the high Q value denotes that a pass-band bandwidth of a corresponding filter is very narrow, and thus only a predetermined frequency component can be extracted.

A pass-band center frequency of a passive filter, such as the electrical filtering unit 100 or 210, is always fixed, and thus the apparatus using such a passive filter is operated at a single transmission speed.

Accordingly hereinafter, a method and device used in an apparatus for restoring clock signals, which can restore the clock signals corresponding to each transmission speed, even when at least one data signal having the different transmission speeds is input to the apparatus, are described.

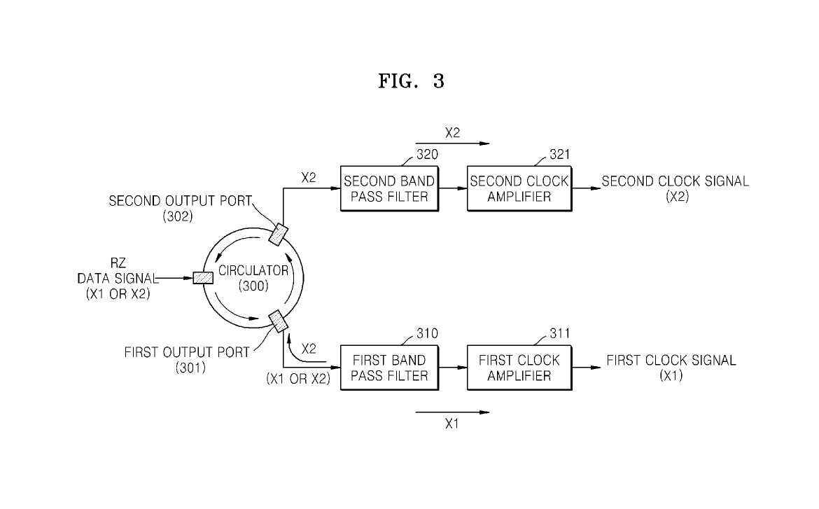

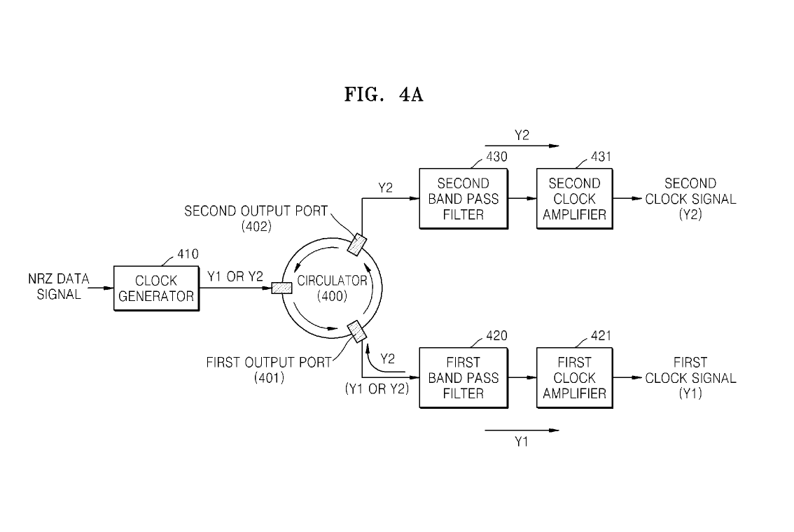

FIG. 3 is a diagram illustrating an apparatus for restoring clock signals, which restores the clock signals corresponding to each transmission speed from RZ data signals having different transmission speeds X1 and X2, according to an embodiment of the present invention.

By using two band pass filters having center frequencies corresponding to each transmission speed X1 or X2 of two types of the RZ data signals, the apparatus can selectively obtain one of clock signals corresponding to the different transmission speeds X1 and X2.

A circulator 300 receives one of the two types of RZ data signal having the different transmission speeds X1 and X2, and allows the received RZ data signal to circulate through two adjacent ports in one direction. Accordingly, when the RZ data signal having the transmission speed X1 is input to the circulator 300, the RZ data signal is transmitted to a first output port 301, and a first clock signal corresponding to the transmission speed X1 is extracted from a first band pass filter 310 having a pass-band center frequency corresponding to the transmission speed X1. Then, a first clock amplifier 311 amplifies the extracted first clock signal.

Meanwhile, when the RZ data signal having the transmission speed X2 is input to the circulator 300, the RZ data signal is first transmitted to the first output port 301, but is reflected at the first band pass filter 310 having the pass-band center frequency corresponding to the transmission speed X1, and thus is transmitted to a second output port 302 of the circulator 300. Since a second band pass filter 320 has a pass-band center frequency corresponding to the transmission speed X2, the second band pass filter 320 extracts a second clock signal corresponding to the transmission speed X2, and a second clock amplifier 321 amplifies the extracted second clock signal.

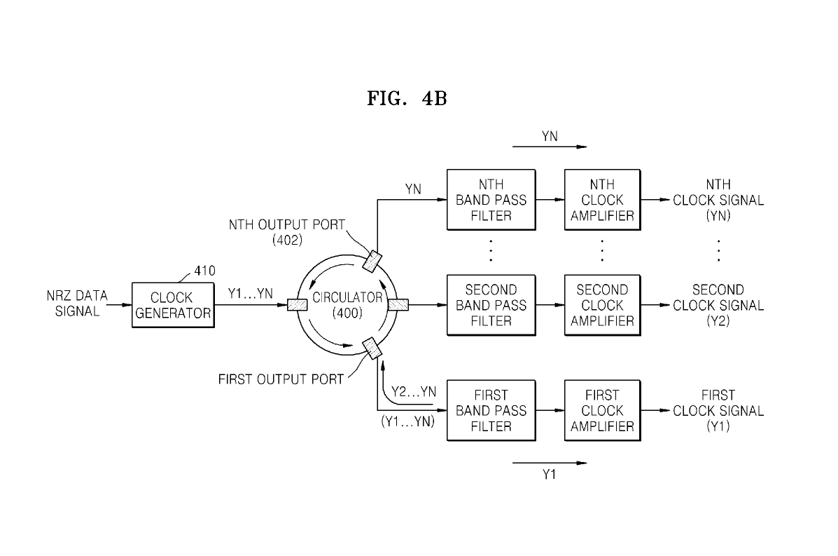

FIGS. 4A and 4B are diagrams illustrating an apparatus for restoring clock signals, which restores the clock signals corresponding to each transmission speed from NRZ data signals having different transmission speeds, according to an embodiment of the present invention.

Since the NRZ data signals input to the apparatus of FIGS. 4A and 4B do not include clock frequency components, the apparatus further includes a clock generator 410, unlike the apparatus of FIG. 3.

When an electrical input signal of the clock generator 410 is an NRZ data signal that does not include a clock frequency component, the clock generator 410 converts the NRZ data signal to a signal including a clock frequency component.

Unlike the conventional clock generator 200 illustrated in FIG. 2, the clock generator 410 according to the current embodiment must be able to process all data signals having different transmission speeds, and thus the clock generator 410 generates clock frequency components corresponding to each transmission speed of various NRZ data signals.

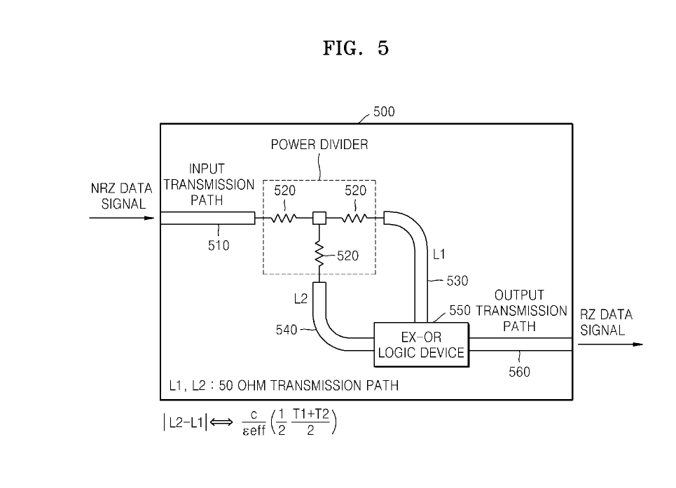

Accordingly, when two types of NRZ data signals having different speeds are input, the clock generator 410 illustrated in FIGS. 4A and 4B generates clock frequency components corresponding to each transmission speed. A process of generating a clock frequency component will be described in detail later with reference to FIG. 5.

A converted signal output from the clock generator 410 in the case of an NRZ signal or an input data signal in the case of an RZ signal is transmitted to the circulator 300 or 400 illustrated in FIGS. 3, 4A, and 4B.

The circulator 300 or 400 allows data signals including clock frequency components to flow through adjacent ports in one direction and outputs the data signals to proper ports, thus a first output port 301 or 401 receives the data signal first. Accordingly, when a time period of a data signal that is input to the circulator 300 or 400 is T1, the data signal transmitted to the first output port 301 or 401 includes a clock frequency component (corresponding to a transmission speed X1 or Y1) corresponding to 1/T1. Alternatively, when the time period is T2, the data signal includes a clock frequency component (corresponding to a transmission speed X2 or Y2) corresponding to 1/T2.

In order to extract the clock frequency component (corresponding to the transmission speed X1 or Y1) corresponding to 1/T1, the first output port 301 or 401 of the circulator 300 or 400 is connected to a first band pass filter 310 or 420 having a center frequency of 1/T1.

Accordingly, when the time period is T1, the clock frequency component (corresponding to the transmission speed X1 or Y1) corresponding to 1/T1 is extracted from the first band pass filter 310 or 420, but when the time period is T2, the clock frequency component (corresponding to the transmission speed X2 or Y2) corresponding to 1/T2 is reflected at the first output port 301 or 401 and is transmitted to a second output port 302 or 402.

Then, the clock frequency component (corresponding to the transmission speed X2 or Y2) corresponding to 1/T2 is extracted from a second band pass filter 320 or 430, as the second output port 302 or 402 is connected to the second band pass filter 320 or 430 having a center frequency of 1/T2.

In detail, when a clock signal is extracted from a data signal including a clock frequency component of 1/T1 or 1/T2 by using the apparatus of the present invention, the pass-band center frequency of the first band pass filter 310 or 420 is 1/T1, the pass-band center frequency of the second band pass filter 320 or 430 is 1/T2, the bandwidths of the first band pass filter 310 or 420 and second band pass filter 320 or 430 are narrow, and clean clock signals are restored as the Q value of the band pass filters is increased.

Each clock frequency component extracted from the first band pass filter 310 or 420 or the second band pass filter 320 or 430 is amplified at the first clock amplifier 311 or 421 or the second clock amplifier 321 or 431. The first clock amplifier 311 or 421 and the second clock amplifier 321 or 431 may be realized by using any type of amplifier, but in particular, it is desirable that monolithic microwave integrated circuit (MMIC) amplifiers are used for integration.

The first and second clock amplifiers 311, 421, 321, and 431 amplify the amplitude of a corresponding clock signal to be sufficient for data recovery and demultiplexing, and maintain the amplitude of a corresponding clock signal to a constant level even when the amplitudes of the input data vary within a wide range. Accordingly, it is desirable that the first clock amplifiers 311 and 421, and the second clock amplifiers 321 and 431 perform an amplifying function only in a corresponding clock frequency range.

FIG. 5 is a diagram illustrating an internal structure of the clock generator 410 in FIGS. 4A and 4B, according to an embodiment of the present invention. In the clock generator 410 of FIG. 4A, an NRZ data signal is limited to two types having different transmission speeds, but the present invention is not limited thereto. In other words, clock frequency components corresponding to each transmission speed of N types of NRZ data signals having N different transmission speeds can be generated.

A clock generator 500 of FIG. 5 includes an input transmission path 510, a power divider 520, a first transmission path 530, a second transmission path 540, an exclusive OR (X-OR) logic device 550, and an output transmission path 560.

When one of NRZ data signals having different transmission speeds is input selectively, the input transmission path 510 transmits the received NRZ data signal to the power divider 520 minimizing a transmission loss of the NRZ data signal.

The power divider 520 is composed of three resistors 520 of equal value. An NRZ data signal having a predetermined transmission speed (one of N transmission speeds) is transmitted to the power divider 520, and is divided into two identical NRZ data signals through the three resistors 520. Then, the two identical NRZ data signals are applied to two input ports of the X-OR logic device 550 respectively via the first and second transmission paths 530 and 540.

In detail, a resistance value of the three resistors 520 is a value obtained by dividing a characteristic impedance of a transmission path by 3. In other words, when a transmission path has a 50Ω characteristic impedance, the resistance value is 16 to 17Ω. However, this is only an embodiment, and can be modified to a substantially the same or similar concept.

The first and second transmission paths 530 and 540 are used to differently delay the two identical NRZ data signals which are a result of the dividing by the power divider 520. In detail, the time difference between two X-OR input signals transmitted through the first and second transmission paths 530 and 540 to obtain the clock frequency components corresponding to each transmission speed is ½ of an average time period of two types of NRZ data signals having different two transmission speeds. When such a time difference is expressed as an equation, it is

$$( \frac{1}{2} \frac{T 1 + T 2}{2} ) .$$

Accordingly, the length difference between the first and second transmission paths 530 and 540 are expressed as Equation 1 below.

$$\vert L 2 - L 1 \vert = \frac{c}{ɛ eff} ( \frac{1}{2} \frac{T 1 + T 2}{2} ) \qquad ( 1 )$$

Here, L1 denotes a length of the first transmission path 530, L2 denotes a length of the second transmission path 540, c denotes the speed of light in a vacuum, and ε_{eff} denotes an effective dielectric constant determined by structures of the first and second transmission paths 530 and 540. In addition, T1 denotes a time period of an NRZ data signal where a Y1 frequency component is generated, and T2 denotes a time period of an NRZ data signal where a Y2 frequency component is generated.

Accordingly, the two identical NRZ data signals transmitted to the two input ports of the X-OR logic device 550 via the first and second transmission paths 530 and 540 have different phases according to the transmission length difference between the first and second transmission paths 530 and 540. The X-OR logic device 550 generates a clock frequency component corresponding to the transmission speed of the input NRZ data signal by performing an X-OR logic operation on the two identical NRZ data signals having the phase difference. Also, the output transmission path 560 transmits an output signal, including the clock frequency component, of the X-OR logic device 550 to the circulator 400 of FIGS. 4A and 4B.

Alternatively, the clock generator 500 may further include an amplifier (not shown) at an output terminal of the X-OR logic device 550 so as to amplify the generated clock frequency component. In other words, when the spectral power of a clock frequency component output from the X-OR logic device 500 is small, a clock signal can be easily extracted from the circuit blocks after the clock generator 410 and 500 by amplifying the spectral power of the clock frequency component.

Equation 2 below shows a length difference of the first and second transmission paths 530 and 540 for generating clock frequency components corresponding to each transmission speed, when N types of NRZ data signals having N different transmission speeds are input. Moreover in this case, the circulator 400 of FIGS. 4A and 4B is a 1:N circulator that allows an input signal to flow through N output ports in one direction, and operation frequencies of N band pass filters and N clock amplifiers are different according to each transmission speed of the N types of data signals.

$$\vert L 2 - L 1 \vert = \frac{c}{ɛ eff} ( \frac{1}{2} \frac{T max + T min}{2} ) \qquad ( 2 )$$

Here, L1 denotes a length of the first transmission path 530, L2 denotes a length of the second transmission path 540, Tmax denotes a time period of an NRZ data signal having the maximum transmission speed among N types of NRZ data signals having different transmission speeds, Tmin denotes a time period of an NRZ data signal having the minimum transmission speed among N types of NRZ data signals having different transmission speeds, c denotes the speed of light in a vacuum, and ε_{eff} denotes an effective dielectric constant determined by structures of the first and second transmission paths 530 and 540.

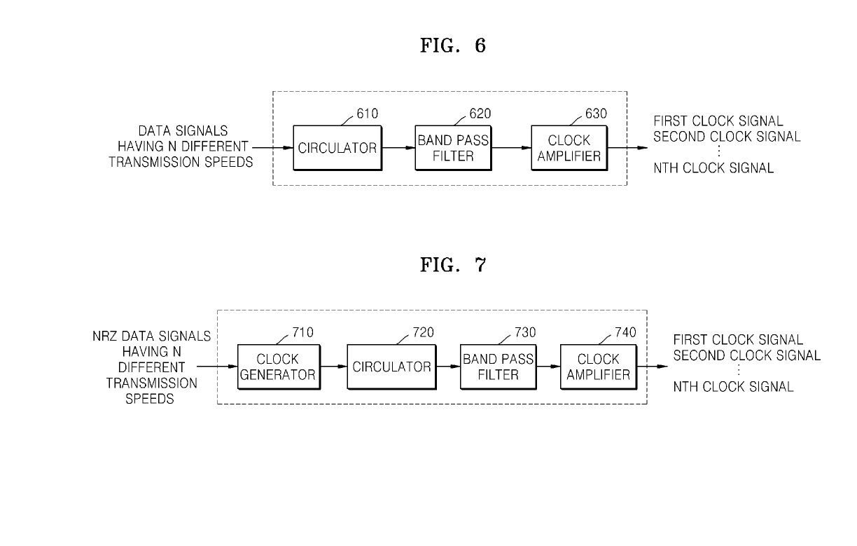

FIG. 6 is a conceptual diagram illustrating an apparatus for restoring clock signals, according to an embodiment of the present invention.

The apparatus for restoring clock signals by using a circulator 610 in an optical transmission system according to the current embodiment includes the circulator 610, which allows N types of data signals having N different transmission speeds to circulate in a single direction, a band pass filter 620, which extracts N types of clock frequency components corresponding to each transmission speed of the N types of data signals that may be input to the circulator 610, and a clock amplifier 630, which amplifies each of the N types of clock frequency components extracted from the band pass filter 620.

FIG. 7 is a conceptual diagram illustrating an apparatus for restoring clock signals from NRZ data signals, according to an embodiment of the present invention.

The apparatus includes a clock generator 710, which generates clock frequency components corresponding to each transmission speed of N types of NRZ data signals having N different transmission speeds, a circulator 720, which allows a signal including the clock frequency component generated by the clock generator 710 to flow in a single direction, N types of band pass filters 730, which extract clock frequency components corresponding to each transmission speed of the N types of NRZ data signals, and N types of clock amplifiers 740, which amplify each extracted clock frequency component.

The pass-band center frequencies of the N types of band pass filters 730 are respectively corresponded to the N transmission speeds. When an input data signal corresponds to a certain pass-band center frequency assigned to the band pass filter 730, the corresponding band pass filter 730 extracts a clock frequency component corresponding to a transmission speed of the input data signal, and when the input data signal does not correspond to the certain pass-band center frequency, the corresponding band pass filter 730 reflects the input data signal to the circulator 720.

According to the present invention, even when N types of data signals having different transmission speeds are selectively input to an apparatus for restoring a clock signal, clock signals corresponding to each transmission speed are extracted by using a circulator and band pass filters. Accordingly, the apparatus can restore clock signals corresponding to various transmission speeds, without installing additional hardware or changing hardware.

The present invention can process various input data signals having different transmission speeds without changing a hardware structure. In other words, the apparatus of the present invention can restore clock signals corresponding to each transmission speed from two or more input data signals having different transmission speeds.

Moreover, by applying the embodiments of the present invention, the apparatus can provide clock signals corresponding to each transmission speed from N types of data signals having different transmission speeds.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for restoring clock signals by using a circulator in an optical transmission system, the apparatus comprising:
a circulator, which has N output ports and, upon receiving selectively one of N types of input data signals having N types of transmission speeds, allows the one input data signal to circulate in a single direction; and
N types of band pass filters, which respectively extract N types of clock frequency components corresponding to the N types of transmission speeds,
wherein each band pass filter passes the received input data signal when a clock frequency component corresponding to the transmission speed of the received input data signal corresponds to the pass-band of the band pass filter, and reflects the received input data signal to the circulator when the clock frequency component corresponding to the transmission speed of the received input data signal does not correspond to the pass-band of the band pass filter.

2. The apparatus of claim 1, wherein the input data signal is a return to zero (RZ) type signal including a clock frequency component.

3. The apparatus of claim 1, further comprising a clock generator, which generates N types of clock frequency components respectively corresponding to the N types of transmission speeds of the N types of input data signals, when the input data signal is a non-return to zero (NRZ) signal not including a clock frequency component.

4. The apparatus of claim 3, wherein an output signal of the clock generator is used as the input data signal of the circulator.

5. The apparatus of claim 3, wherein the clock generator generates the N types of clock frequency components respectively corresponding to the N types of transmission speeds of the N types of input data signals based on an exclusive OR (X-OR) operation.

6. The apparatus of claim 5, wherein the clock generator equally divides one input data signal among the N types of input data signals into two branch signals, transmits the two branch signals via a first transmission path and a second transmission path having different transmission lengths, and then performs the X-OR operation,
wherein a transmission time difference between the first and second transmission paths are ½ of an average value of Tmax, which is a time period of an NRZ input data signal having the maximum transmission speed among the N types of input data signals having different transmission speeds, and Tmin, which is a time period of an NRZ input data signal having the minimum transmission speed among the N types of input data signals having different transmission speeds.

7. The apparatus of claim 1, further comprising clock amplifiers, which amplify each of the N types of clock frequency components.
